(19) United States
(12) Patent Application Publication
(10) Pub. No.: US 2014/0186682 A1
(43) Pub. Date: Jul. 3, 2014

(54) NON-AQUEOUS ELECTROLYTE SECONDARY BATTERY

(71) Applicants: Kunihiko Koyama, Ibaraki-shi (JP); Toshiyuki Watanabe, Ibaraki-shi (JP); Takahiro Furutani, Ibaraki-shi (JP); Eri Kojima, Ibaraki-shi (JP); Masato Harigae, Ibaraki-shi (JP)

(72) Inventors: Kunihiko Koyama, Ibaraki-shi (JP); Toshiyuki Watanabe, Ibaraki-shi (JP); Takahiro Furutani, Ibaraki-shi (JP); Eri Kojima, Ibaraki-shi (JP); Masato Harigae, Ibaraki-shi (JP)

(73) Assignee: HITACHI, LTD., Tokyo (JP)

(21) Appl. No.: 13/813,361

(22) PCT Filed: Mar. 13, 2012
(86) PCT No.: PCT/JP2012/056401

§ 371 Date: Jan. 30, 2013

(51) Int. Cl. H01M 2/16

(52) U.S. Cl. CPC H01M 2/1686
USPC 429/145; 429/246

(57) ABSTRACT

A non-aqueous electrolyte secondary battery of the present invention includes a positive electrode, a negative electrode, and a non-aqueous electrolyte. An insulating layer is provided between the positive electrode and the negative electrode. The insulating layer contains at least one type of hydrogen carbonate selected from a sodium hydrogen carbonate and a potassium hydrogen carbonate. The hydrogen carbonate has an average particle size of 2 to 20 μm. A content of the hydrogen carbonate is 5 to 80 vol % of the total volume of the insulating layer. The insulating layer has a thickness of 4 to 40 μm.

### TECHNICAL FIELD

The present invention relates to a non-aqueous electrolyte secondary battery having excellent safety when the temperature of the battery rises.

### BACKGROUND ART

A non-aqueous electrolyte secondary battery such as a lithium ion secondary battery is characterized by a high energy density and thus has been widely used as a power source for portable equipment such as a portable telephone and a notebook personal computer. It is increasingly important to improve various battery characteristics and safety as the performance of the portable equipment becomes higher.

In the current lithium ion secondary battery, e.g., a polyolefin-based porous film with a thickness of about 20 to 30 μm is used as a separator that is interposed between a positive electrode and a negative electrode. The use of the polyolefin-based porous film can ensure a so-called shutdown effect. During the shutdown, the resin constituting the separator is melted at a temperature of 130 to 140° C., which is not more than the abnormal heat generation temperature of the battery, and the pores of the separator are closed. This increases the internal resistance of the battery, thereby improving the safety of the battery when a short circuit or the like occurs.

By the way, in the case of a non-aqueous electrolyte secondary battery that requires high-power, high-current characteristics, in recent years, the internal resistance has had to be reduced by making the thickness of the separator as small as possible. However, the thinner the separator is, the more difficult it is to handle. Therefore, a method for forming the separator directly on the electrode has been proposed (Patent Document 1). However, the separator formed by this conventional method does not have a shutdown function that is to be performed when the battery reaches a high temperature. In order to provide the separator with a shutdown function, the conventional polyolefin-based porous film needs to be inserted between the electrodes, which results in an increase in the total thickness of the separator.

On the other hand, there has been an attempt to suppress the abnormal heat generation or overcharge of the battery by using a compound that decomposes and generates a gas when the temperature rises so as to improve the safety of the battery (Patent Document 2). Specifically, a gas generating substance such as a carbonate is contained in the surface or the inside of an electrolyte layer. When the temperature of the battery rises, the compound decomposes and generates a gas such as a carbonic acid gas, so that the positive electrode and the negative electrode are separated from each other to increase the internal resistance, and thus the reaction of the battery is stopped.

### PRIOR ART DOCUMENTS

### Patent Documents

Patent Document 1: JP 2006-147569 A
Patent Document 2: JP 2008-226807 A

### DISCLOSURE OF INVENTION

### Problem to be Solved by the Invention

However, in the technology taught by Patent Document 2, it is difficult to control the gas generation temperature, and consequently the gas generation temperature varies greatly. Therefore, it is difficult to perform the shutdown function reliably at about 120 to 150° C., like the conventional polyolefin-based porous film.

The present invention has solved the above problem and provides a non-aqueous electrolyte secondary battery that includes an insulating layer containing a gas generating substance that allows the shutdown function to be reliably performed at about 120 to 150° C.

### Means for Solving Problem

A non-aqueous electrolyte secondary battery of the present invention includes a positive electrode, a negative electrode, and a non-aqueous electrolyte. An insulating layer is provided between the positive electrode and the negative electrode. The insulating layer contains at least one type of hydrogen carbonate selected from a sodium hydrogen carbonate and a potassium hydrogen carbonate. The hydrogen carbonate has an average particle size of 2 to 20 μm. A content of the hydrogen carbonate is 5 to 80 vol % of the total volume of the insulating layer. The insulating layer has a thickness of 4 to 40 μm.

### Effects of the Invention

The present invention can provide a non-aqueous electrolyte secondary battery that can perform the shutdown function reliably when the battery temperature reaches about 120 to 150° C.

### BRIEF DESCRIPTION OF DRAWING

FIG. 1 is a plan view showing a laminated-type non-aqueous electrolyte secondary battery of the present invention.

### DESCRIPTION OF THE INVENTION

A non-aqueous electrolyte secondary battery of the present invention includes a positive electrode, a negative electrode, and a non-aqueous electrolyte. An insulating layer is provided between the positive electrode and the negative electrode. The insulating layer contains at least one type of hydrogen carbonate selected from a sodium hydrogen carbonate and a potassium hydrogen carbonate. The hydrogen carbonate has an average particle size of 2 to 20 μm. A content of the hydrogen carbonate is 5 to 80 vol % of the total volume of the insulating layer. The insulating layer has a thickness of 4 to 40 μm.

With this configuration, the non-aqueous electrolyte secondary battery can perform the shutdown function reliably when the battery temperature reaches about 120 to 150° C.

<Insulating Layer>

The insulating layer contains at least one type of hydrogen carbonate that is selected from a sodium hydrogen carbonate and a potassium hydrogen carbonate, and that has an average particle size of 2 to 20 μm. These hydrogen carbonates decompose and generate a non-flammable gas such as a carbonic acid gas when the temperature rises by heating. Due to the pressure of the gas generated, the positive electrode and the negative electrode are separated from each other to increase the internal resistance, and thus the reaction of the battery can be stopped. In other words, the shutdown function can be performed by incorporating the hydrogen carbonate into the insulating layer. Since the hydrogen carbonate generates the non-flammable gas at a temperature lower than the temperature at which a flammable gas is generated by the volatilization of a non-aqueous electrolytic solution, the generation of the flammable gas also can be suppressed, and the safety of the battery can be further improved.

Moreover, the average particle size of the hydrogen carbonate is set to 2 to 20 μm. Therefore, when the battery temperature reaches about 120 to 150° C., the hydrogen carbonate decomposes, efficiently generates the non-flammable gas, and allows the shutdown function to be reliably performed. By setting the average particle size of the hydrogen carbonate to 2 to 20 μm, the gas generation temperature can be in the range of 120 to 150° C., and more preferably in the range of 130 to 140° C. The average particle size of the hydrogen carbonate is more preferably 5 μm or more and 15 μm or less.

In the present specification, the average particle size of the various particles means a number average particle size that is measured, e.g., with a laser diffraction particle size analyzer (e.g., LA-920 manufactured by Horiba, Ltd.) by dispersing the particles to be measured in a medium, in which the particles are insoluble.

It is preferable that the hydrogen carbonate is heat-treated at a temperature lower than the decomposition temperature of the hydrogen carbonate. This can remove moisture adsorbed on the hydrogen carbonate, and also can prevent moisture from entering the battery. If the moisture is brought into the battery, the battery characteristics may be degraded. The decomposition temperature of the hydrogen carbonate can be made constant with the above heat treatment, and thus the shutdown temperature can be set more accurately. The heat treatment temperature may be lower than the decomposition temperature of the hydrogen carbonate, and is generally 100° C. or lower, and preferably 60 to 90° C.

The content of the hydrogen carbonate is set to 5 to 80 vol % of the total volume of the insulating layer. If the content of the hydrogen carbonate is too low, the shutdown function cannot be performed. If the content of the hydrogen carbonate is too high, the insulation properties are reduced, and a short circuit may occur. The content of the hydrogen carbonate is more preferably 20 vol % or more and 60 vol % or less.

The insulating layer also serves as a separator. If the thickness of the insulating layer is too small, the insulation properties are reduced. If the thickness of the insulating layer is too large, the volumetric energy density of the battery is reduced. Therefore, the thickness of the insulating layer is set to 4 to 40 μm, and more preferably 10 μm or more and 30 μm or less.

It is preferable that the insulating layer further contains a resin having a cross-linked structure and inorganic particles, and also has micropores. The presence of the resin having the cross-linked structure improves the heat resistance of the insulating layer, and the presence of the inorganic particles facilitates the formation of the micropores. The porosity of the insulating layer is not particularly limited as long as the insulating layer is permeable to the electrolytic solution to be used, and is generally about 30 to 75%.

(Resin Having Cross-Linked Structure)

The resin having the cross-linked structure (referred to as a resin (A) in the following) is a resin that has a cross-linked structure in part. Therefore, even if the temperature in the non-aqueous electrolyte secondary battery including the insulating layer of the present invention is high, the insulating layer is not likely to shrink or to be deformed by the melting of the resin (A), and thus is maintained in a good shape. This can suppress the occurrence of a short circuit between the positive electrode and the negative electrode. Accordingly, the non-aqueous electrolyte secondary battery including the insulating layer of the present invention has excellent safety at a high temperature.

The glass transition temperature (Tg) of the resin (A) is higher than 0° C., preferably 10° C. or higher and is lower than 80° C., preferably 60° C. or lower. When the resin (A) has the Tg in the above range, favorable pores can be formed in the insulating layer, and the lithium ion permeability of the insulating layer can be improved. Therefore, the use of this resin (A) can enhance the charge-discharge cycle characteristics and the load characteristics of the non-aqueous electrolyte secondary battery. If the Tg of the resin (A) is too low, the pores are easily filled, making it difficult to adjust the lithium ion permeability of the insulating layer. If the Tg of the resin (A) is too high, curing and shrinkage occur during the production of the insulating layer, and favorable pores are not likely to be formed. Consequently, it is still difficult to adjust the lithium ion permeability of the insulating layer.

The resin (A) can be obtained by irradiating oligomers, which can be polymerized by energy ray irradiation, with an energy ray and polymerizing the oligomers. When the resin (A) is formed by the polymerization of the oligomers, the insulating layer can have high flexibility and resistance to peeling as it is joined to the electrode. Moreover, it becomes easy to control the Tg of the resin (A) in the above range.

It is preferable that monomers that can be polymerized by energy ray irradiation are used together with the oligomers to form the resin (A).

The production of the insulating layer containing the resin (A) preferably includes the following steps: preparing a solution for forming an insulating layer that includes the oligomers or the like for forming the resin (A), a solvent, etc.; applying the solution to the electrode to form a coating; and irradiating the coating with the energy ray to form the resin (A). In this case, when the monomers are added along with the oligomers to the solution for forming an insulating layer, the viscosity of the solution can be easily controlled, and the application properties of the solution to the electrode can be improved, thus imparting superior properties to the insulating layer. Moreover, the use of the monomers facilitates the control of the cross-linking density of the resin (A), so that the Tg of the resin (A) is also easier to control.

Specific examples of the resin (A) include the following: an acrylic resin composed of acrylic resin monomers (alkyl(meth)acrylates such as methyl methacrylate and methyl acrylate and their derivatives) and oligomers of these monomers and a cross-linking agent; a cross-linked resin composed of urethane acrylate and a cross-linking agent; a cross-linked resin composed of epoxy acrylate and a cross-linking agent; and a cross-linked resin composed of polyester acrylate and a cross-linking agent. In the above resins, the cross-liking agents may be divalent or polyvalent acrylic monomers (difunctional acrylate, trifunctional acrylate, tetrafunctional acrylate, pentafunctional acrylate, hexafunctional acrylate, etc.) such as tripropylene glycol diacrylate, 1,6-hexanediol diacrylate, tetraethylene glycol diacrylate, polyethylene glycol diacrylate, dioxane glycol diacrylate, tricyclodecane dimethanol diacrylate, ethylene oxide modified trimethylolpropane triacrylate, dipentaerythritol pentaacrylate, caprolactone modified dipentaerythritol hexaacrylate, and ε-caprolactone modified dipentaerythritol hexaacrylate.

When the resin (A) is the acrylic resin, the oligomers of any of the above acrylic resin monomers can be used as the oligomers that can be polymerized by energy ray irradiation (simply referred to as “oligomers” in the following), and any of the above acrylic resin monomers and cross-linking agents can be used as the monomers that can be polymerized by energy ray irradiation (simply referred to as “monomers” in the following).

Moreover, when the resin (A) is the cross-linked resin composed of the urethane acrylate and the cross-linking agent, the urethane acrylate can be used as the oligomers, and any of the above cross-linking agents can be used as the monomers.

On the other hand, when the resin (A) is the cross-linked resin composed of the epoxy acrylate and the cross-linking agent, the epoxy acrylate can be used as the oligomers, and any of the above cross-linking agents can be used as the monomers.

Further, when the resin (A) is the cross-linked resin composed of the polyester acrylate and the cross-linking agent, the polyester acrylate can be used as the oligomers, and any of the above cross-linking agents can be used as the monomers.

For the synthesis of the resin (A), at least two of the urethane acrylate, the epoxy acrylate, and the polyester acrylate may be used as the oligomers, and at least two of the difunctional acrylate, the trifunctional acrylate, the tetrafunctional acrylate, the pentafunctional acrylate, and the hexafunctional acrylate may be used as the cross-linking agents (monomers).

Examples of the resin (A) also include the following: a cross-linked resin derived from an unsaturated polyester resin that is formed from a mixture of an ester composition and styrene monomers, the ester composition being produced by the condensation polymerization of dihydric or polyhydric alcohol and a dicarboxylic acid; and various polyurethane resins produced by the reaction between polyisocyanate and polyol.

When the resin (A) is the cross-linked resin derived from the unsaturated polyester resin, the above ester composition can be used as the oligomers, and the styrene monomers can be used as the monomers.

When the resin (A) is the various polyurethane resins produced by the reaction between polyisocyanate and polyol, the polyisocyanate may be, e.g., hexamethylene diisocyanate, phenylene diisocyanate, toluene diisocyanate (TDI), 4,4′-diphenylmethane diisocyanate (MDI), isophorone diisocyanate (IPDI), or bis-(4-isocyanatocyclohexyl)methane, and the polyol may be, e.g., polyether polyol, polycarbonate polyol, or polyester polyol.

Thus, when the resin (A) is the various polyurethane resins produced by the reaction between polyisocyanate and polyol, any of the above polyols can be used as the oligomers, and any of the above polyisocyanates can be used as the monomers.

For the formation of the resin (A) in each of the above examples, monofunctional monomers such as isobornyl acrylate, methoxypolyethylene glycol acrylate, and phenoxypolyethylene glycol acrylate also can be used together. Therefore, when the resin (A) has a structure derived from these monofunctional monomers, any of the above monofunctional monomers can be used as the monomers along with the oligomers and the other monomers, as described above.

However, the monofunctional monomers are likely to remain as unreacted substances in the resin (A) thus formed, and there is a risk that the unreacted substances remaining in the resin (A) will dissolve in the non-aqueous electrolyte of the non-aqueous electrolyte secondary battery and impair the cell reaction. Therefore, the oligomers and the monomers used to form the resin (A) preferably have not less than two functional groups. Also, the oligomers and the monomers used to form the resin (A) preferably have not more than six functional groups.

To further facilitate the control of the Tg, when both the oligomers and the monomers are used to form the resin (A), the mass ratio of the oligomers and the monomers is preferably 20:80 to 95:5, and more preferably 65:35 to 90:10. That is, in the resin (A) composed of the oligomers and the monomers, the mass ratio of units derived from the oligomers and units derived from the monomers is preferably 20:80 to 95:5, and more preferably 65:35 to 90:10.

The content of the resin (A) in the insulating layer is preferably 20 to 75 vol %. If the content of the resin (A) is less than 20 vol %, the adhesive strength between the electrode and the insulating layer is insufficient, so that the insulating layer easily comes off. On the other hand, if the content of the resin (A) is more than 75 vol %, the pores are not likely to be formed, so that the formation of micropores is difficult. Moreover, the load characteristics of the battery tend to be low.

(Inorganic Particles)

When the insulating layer contains the hydrogen carbonate and inorganic particles other than the hydrogen carbonate (referred to as inorganic particles (B) in the following), the strength and dimensional stability of the insulating layer can be further improved.

Specific examples of the inorganic particles (B) include the following: particles of inorganic oxides such as an iron oxide, silica (SiO₂), alumina (Al₂O₃), TiO₂ (titania), and BaTiO₃; particles of inorganic nitrides such as an aluminum nitride and a silicon nitride; particles of hardly-soluble ionic crystals such as a calcium fluoride, a barium fluoride, and a barium sulfate; particles of covalent crystals such as silicon and diamond; and fine particles of clays such as montmorillonite. The inorganic oxide particles may be fine particles of materials derived from the mineral resources such as boehmite, zeolite, apatite, kaoline, mullite, spinel, olivine, and mica or artificial products of these materials. Moreover, the inorganic particles may be electrically insulating particles obtained by covering the surface of a conductive material with a material having electrical insulation (e.g., any of the above inorganic oxides). Examples of the conductive material include conductive oxides such as a metal, SnO₂, and an indium tin oxide (ITO) and carbonaceous materials such as carbon black and graphite. The above examples of the inorganic particles may be used individually or in combination of two or more. Among the above examples of the inorganic particles, the inorganic oxide particles are more preferred, and alumina, titania, silica, and boehmite are even more preferred.

The average particle size of the inorganic particles (B) is preferably 0.001 μm or more, and more preferably 0.1 μm or more. Moreover, the average particle size of the inorganic particles (B) is preferably 20 μm or less, and more preferably 1 μm or less.

The inorganic particles (B) may be, e.g., either in the form of substantially spherical particles or in the form of plate-like or fibrous particles. In terms of improving the short circuit resistance of the insulating layer, the inorganic particles (B) are preferably plate-like particles or particles having a secondary particle structure in which primary particles are agglomerated. Particularly, in terms of improving the porosity of the insulating layer, the particles having the secondary particle structure are more preferred. Typical examples of the plate-like particles and the secondary particles include alumina or boehmite plate-like particles and alumina or boehmite secondary particles.

The content of the inorganic particles (B) in the insulating layer may be 20 to 60 vol %.

It is preferable that the insulating layer is formed on the positive electrode or the negative electrode. The electrode and the insulating layer can be integrally formed from the beginning so as to improve the efficiency of the manufacturing process of the battery. Such an integrated component of the electrode and the insulating layer can be formed, e.g., by applying the solution for forming an insulating layer to the electrode.

When the insulating layer does not contain the resin having the cross-linked structure and the inorganic particles, it is preferable that a microporous film is provided as a base material of the insulating layer. The use of the microporous film as the base material can improve the strength of the insulating layer. In this case, the hydrogen carbonate may be located in the inside or the surface of the microporous film.

The microporous film may be, e.g., a polyolefin microporous film, which has been conventionally used for the separator of the non-aqueous electrolyte secondary battery. Thus, the microporous film itself can have the shutdown function. If necessary, the hydrogen carbonate and the microporous film can be bonded together with a binder, thereby preventing the hydrogen carbonate from falling off the microporous film. The binder may be, e.g., a binder used for the positive electrode or the negative electrode, as will be described later.

<Positive Electrode>

The positive electrode may have a structure in which, e.g., a positive electrode mixture layer that includes a positive electrode active material, a conductive assistant, a binder, and the like is provided on one side or both sides of a current collector.

The positive electrode active material is not particularly limited as long as it is an active material capable of intercalating and deintercalating Li ions. Examples of the positive electrode active material include the following: a lithium-containing transition metal oxide having a layered structure expressed as Li₁₊ₓMO₂ (−0.1<x<0.1, M: Co, Ni, Mn, Al, Mg, etc.); a lithium manganese oxide having a spinel structure expressed as LiMn₂O₄ or other formulas in which a part of the elements of LiMn₂O₄ is substituted with another element; and an olivine-type compound expressed as LiMPO₄ (M: Co, Ni, Mn, Fe, etc.). Specific examples of the lithium-containing transition metal oxide having the layered structure include LiCoO₂, LiNi₁₋ₓCo_{x-y}Al_{y}O₂ (0.1≦x≦0.3, 0.01≦y≦0.2), and oxides containing at least Co, Ni, and Mn (such as LiMn_{1/3}Ni_{1/3}Co_{1/3}O₂, LiMn_{5/12}Ni_{5/12}Co_{1/6}O₂, and LiNi_{3/5}Mn_{1/5}Co_{1/5}O₂).

The conductive assistant may be a carbon material such as carbon black. The binder may be a fluorocarbon resin such as polyvinylidene fluoride (PVDF).

The current collector may be, e.g., a metal foil, a punching metal, a mesh, or an expanded metal made of aluminum or the like. In general, an aluminum foil with a thickness of 10 to 30 μm can be suitably used.

The positive electrode has a lead portion. The lead portion is generally provided in the following manner. A part of the current collector remains exposed without forming the positive electrode mixture layer when the positive electrode is produced, and thus this exposed portion can serve as the lead portion. However, the lead portion does not necessarily need to be integrated with the current collector from the beginning and may be provided by connecting an aluminum foil or the like to the current collector afterward.

<Negative Electrode>

The negative electrode may have a structure in which, e.g., a negative electrode mixture layer that includes a negative electrode active material, a binder, and optionally a conductive assistant is provided on one side or both sides of a current collector.

The negative electrode active material is not particularly limited as long as it is a material capable of intercalating and deintercalating lithium ions. For example, the negative electrode active material may be one type of carbon materials capable of intercalating and deintercalating lithium ions such as graphite, pyrolytic carbon, coke, glassy carbon, a calcined organic polymer compound, mesocarbon microbeads (MCMB), and a carbon fiber, or a mixture of two or more types of the carbon materials. Examples of the negative electrode active material also include the following: elements such as silicon (Si), tin (Sn), germanium (Ge), bismuth (Bi), antimony (Sb), and indium (In) and their alloys; compounds that can be charged/discharged at a low voltage close to lithium metal such as a lithium-containing nitride and a lithium-containing oxide; a lithium metal; and a lithium/aluminum alloy.

A material containing silicon (Si) as a constituent element is particularly preferred for the negative electrode active material. The use of this material can provide the non-aqueous electrolyte secondary battery with high capacity and excellent charge-discharge cycle characteristics and load characteristics.

Examples of the material containing Si as a constituent element include materials that electrochemically react with Li such as an Si element, an alloy of Si and an element other than the Si such as Co, Ni, Ti, Fe, or Mn, and an oxide of Si. Among them, a material containing Si and O as constituent elements, which is expressed as a general composition formula SiOₚ (where 0.5≦p≦1.5), is suitably used. In the above examples of the material containing Si as a constituent element, the alloy of Si and the element other than the Si may be either a single solid solution or an alloy including a plurality of phases of an Si element phase and an Si alloy phase.

The SiOₚ is not limited only to the oxide of Si, but may include a microcrystalline phase of Si or an amorphous phase of Si. In this case, the atomic ratio of Si and O is determined by incorporating the microcrystalline phase of Si or the amorphous phase of Si. In other words, the material expressed as SiOₚ includes, e.g., a structure in which Si (e.g., microcrystalline Si) is dispersed in an amorphous SiO₂ matrix, and p of the atomic ratio, incorporating the amorphous SiO₂ and the Si dispersed in the amorphous SiO₂, may satisfy 0.5≦p≦1.5. For example, when a material has a structure in which Si is dispersed in the amorphous SiO₂ matrix, and the molar ratio of SiO₂ and Si is 1:1, this material is represented by SiO because p=1 is established. In the case of the material having such a structure, a peak due to the presence of Si (microcrystalline Si) may not be observed, e.g., by X-ray diffraction analysis, but the presence of fine Si can be confirmed by transmission electron microscope (TEM) observation.

<Non-Aqueous Electrolyte>

The non-aqueous electrolyte may be a non-aqueous electrolytic solution in which a lithium salt is dissolved in an organic solvent. The lithium salt used for the non-aqueous electrolytic solution is not particularly limited as long as it dissociates in the solvent to produce a lithium ion and is not likely to cause a side reaction such as decomposition in the working voltage range of the battery. Examples of the lithium salt include inorganic lithium salts such as LiClO₄, LiPF₆, LiBF₄, LiAsF₆, and LiSbF₆, and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7), and LiN(RfOSO₂)₂ (where Rf represents a fluoroalkyl group).

The concentration of the lithium salt in the non-aqueous electrolytic solution is preferably 0.5 to 1.5 mol/L, and more preferably 0.9 to 1.25 mol/L.

The organic solvent used for the non-aqueous electrolytic solution is not particularly limited as long as it dissolves the lithium salt and does not cause a side reaction such as decomposition in the working voltage range of the battery. Examples of the organic solvent include the following: cyclic carbonates such as ethylene carbonate, propylene carbonate, and butylene carbonate; chain carbonates such as dimethyl carbonate, diethyl carbonate, and methyl ethyl carbonate; chain esters such as methyl propionate; cyclic esters such as γ-butyrolactone; chain ethers such as dimethoxyethane, diethyl ether, 1,3-dioxolane, diglyme, triglyme, and tetraglyme; cyclic ethers such as dioxane, tetrahydrofuran, and 2-methyltetrahydrofuran; nitriles such as acetonitrile, propionitrile, and methoxypropionitrile; and sulfurous esters such as ethylene glycol sulfite. The organic solvent may be a mixture of two or more of these materials. A combination of the materials capable of achieving a high conductivity, e.g., a mixed solvent of the ethylene carbonate and the chain carbonate is preferred for better characteristics of the battery.

<Separator>

In the non-aqueous electrolyte secondary battery of the present invention, a separator is not generally required, since the insulating layer is formed between the positive electrode and the negative electrode. However, a separator may be further provided between the positive electrode and the negative electrode. This configuration can prevent a short circuit between the positive electrode and the negative electrode more reliably.

The separator may be a polyolefin microporous film. Thus, the separator also can have the shutdown function. Examples of the polyolefin include the following: polyethylene (PE); polypropylene (PP); copolymerized polyolefin; a polyolefin derivative (such as chlorinated polyethylene); and a polyolefin wax.

Although a commercially available polyolefin microporous film may be used, the microporous film is preferably composed of fine particles of the above polyolefin, and particularly preferably composed of polyethylene fine particles. The commercially available polyolefin separator is subjected to drawing during the production process. Therefore, when the temperature rises to near the shutdown temperature, the commercially available polyolefin separator shrinks and breaks the insulating layer, so that a short circuit may occur in the battery. However, such a problem can be prevented by using the microporous film composed of the polyolefin fine particles.

The particle size of the polyolefin fine particles is not particularly limited, and the average particle size is preferably 0.1 to 20 μm. If the particle size of the polyolefin fine particles is too small, the space between the particles is reduced, and the lithium ion conduction path becomes longer. Thus, the characteristics of the non-aqueous electrolyte secondary battery may be degraded. If the particle size of the polyolefin fine particles is too large, the space between the particles is increased, which in turn may reduce the effect of improving resistance to a short circuit caused by lithium dendrites or the like.

The thickness of the polyolefin microporous film is not particularly limited, and may be 1 to 10 μm. If the thickness of the polyolefin microporous film is too large, the energy efficiency of the battery is reduced. If the thickness of the polyolefin microporous film is too small, handling is difficult.

<Battery Form>

The non-aqueous electrolyte secondary battery of the present invention is preferably in the form of a laminated-type battery that uses a soft, metal-deposited laminated film as an outer package. The soft outer package allows the positive electrode to be easily separated from the negative electrode at the time of the generation of a gas from the hydrogen carbonate. The present invention also can be applied to a cylindrical (e.g., a rectangular or circular cylinder) battery that uses an outer can made of steel, aluminum, or the like. This is because even if the outer can is rigid, the internal resistance is increased by the gas generated from the hydrogen carbonate and held between the positive electrode and the negative electrode.

### EXAMPLES

### Example 1

### Preparation of Solution for Forming Insulating Layer

First, a sodium hydrogen carbonate with an average particle size of 3 μm was heat-treated at 70° C. Next, the heat-treated sodium hydrogen carbonate and the following materials were placed in a container at the following ratios, and then stirred for 12 hours to prepare a solution for forming an insulating layer.

(1) Sodium hydrogen carbonate (heat-treated at 70° C., average particle size: 3 μm): 18 parts by mass

(2) Boehmite (inorganic particles, average particle size: 0.6 μm): 11 parts by mass

(3) Urethane acrylate (polymerizable oligomer, “EBECRYL 8405” manufactured by DAICEL-CYTEC Company Ltd.): 4 parts by mass

(4) Tripropylene glycol diacrylate (polymerizable monomer): 1 part by mass

(5) Methyl ethyl ketone: 58.9 parts by mass

(6) Ethylene glycol: 5.7 parts by mass

(7) Bis(2,4,6-trimethylbenzoyl)-phenylphosphine oxide (polymerization initiator): 0.2 parts by mass

<Production of Positive Electrode>

A positive electrode mixture containing paste was prepared by mixing 20 parts by mass of LiNi_{0.5}Co_{0.2}Mn_{0.3}O₂ and 80 parts by mass of LiCoO₂ (which were positive electrode active materials), 7 parts by mass of acetylene black (conductive assistant), and 3 parts by mass of PVDF (binder) uniformly by using N-methyl-2-pyrrolidone (NMP) as a solvent. Subsequently, the positive electrode mixture containing paste was uniformly applied to one side of an aluminum foil (current collector) having a thickness of 15 μm, which then was dried at 85° C., and further subjected to vacuum drying at 100° C. Thereafter, the resultant aluminum foil was pressed by a roller press to form a positive electrode. When the positive electrode mixture containing paste was applied to the aluminum foil, a portion of the aluminum foil was left uncoated and exposed.

Next, the positive electrode was cut so that the area of the positive electrode mixture layer was 30 mm×30 mm, and the exposed portion of the aluminum foil was contained. Moreover, an aluminum lead piece for drawing a current was welded to the exposed portion of the aluminum foil. Thus, the positive electrode provided with a lead was produced.

<Production of Integrated Component of Positive Electrode and Insulating Layer>

Next, the solution for forming an insulating layer was applied to the positive electrode mixture layer of the positive electrode, irradiated with an ultraviolet ray having a wavelength of 365 nm at an irradiance of 1000 mW/cm² for 10 seconds, and dried at 60° C. for 1 hour. Thus, an insulating layer with a thickness of 20 μm was formed on the negative electrode.

<Production of Negative Electrode>

A negative electrode mixture containing paste was prepared by mixing 95 parts by mass of graphite (negative electrode active material) and 5 parts by mass of PVDF (binder) uniformly by using NMP as a solvent. Subsequently, the negative electrode mixture containing paste was uniformly applied to one side of a copper foil (current collector) having a thickness of 10 μm, which then was dried at 85° C., and further subjected to vacuum drying at 100° C. Thereafter, the resultant copper foil was pressed by a roller press to form a negative electrode. When the negative electrode mixture containing paste was applied to the copper foil, a portion of the copper foil was left uncoated and exposed.

Next, the negative electrode was cut so that the area of the negative electrode mixture layer was 35 mm×35 mm, and the exposed portion of the copper foil was contained. Moreover, a nickel lead piece for drawing a current was welded to the exposed portion of the copper foil. Thus, the negative electrode provided with a lead was produced.

<Assembly of Battery>

The positive electrode provided with the lead and the negative electrode provided with the lead were superimposed via a PE microporous film separator (thickness: 18 μm) to form a laminated electrode body. The laminated electrode body was inserted into an outer package made of an aluminum laminated film of 90 mm×160 mm. Subsequently, a non-aqueous electrolytic solution was obtained by dissolving LiPF₆ at a concentration of 1.2 mol/L in a mixed solvent containing an ethylene carbonate and a dimethyl carbonate at a volume ratio of 2:8, and 1 mL of the non-aqueous electrolytic solution was injected into the outer package. Then, the outer package was sealed, providing a laminated-type non-aqueous electrolyte secondary battery.

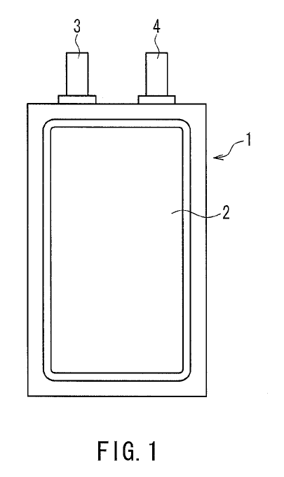

FIG. 1 is a plan view showing the laminated-type non-aqueous electrolyte secondary battery thus produced. In FIG. 1, the laminated-type non-aqueous electrolyte secondary battery 1 of this example is configured so that the laminated electrode body and the non-aqueous electrolytic solution are housed in the outer package 2 that is made of an aluminum laminated film and is rectangular in shape when seen in a plan view. Moreover, a positive electrode external terminal 3 and a negative electrode external terminal 4 are drawn from the same side of the outer package 2.

### Example 2

A laminated-type non-aqueous electrolyte secondary battery was produced in the same manner as Example 1 except that the sodium hydrogen carbonate had an average particle size of 17 μm.

### Example 3

A laminated-type non-aqueous electrolyte secondary battery was produced in the same manner as Example 1 except that the sodium hydrogen carbonate had an average particle size of 10 μm and the insulating layer had a thickness of 7 μm.

### Example 4

A laminated-type non-aqueous electrolyte secondary battery was produced in the same manner as Example 1 except that the sodium hydrogen carbonate had an average particle size of 10 μm and the insulating layer had a thickness of 35 μm.

### Example 5

A sodium hydrogen carbonate with an average particle size of 10 μm was heat-treated in the same manner as Example 1. The heat-treated sodium hydrogen carbonate and the following materials were placed in a container at the following ratios, and then stirred for 12 hours to prepare a solution for forming an insulating layer.

(1) Sodium hydrogen carbonate (heat-treated at 70° C., average particle size: 10 μm): 2.5 parts by mass

(2) Boehmite (inorganic particles, average particle size: 0.6 μm): 20 parts by mass

(3) Urethane acrylate (polymerizable oligomer, “EBECRYL 8405” manufactured by DAICEL-CYTEC Company Ltd.): 6 parts by mass

(4) Tripropylene glycol diacrylate (polymerizable monomer): 1.5 parts by mass

(5) Methyl ethyl ketone: 58.9 parts by mass

(6) Ethylene glycol: 5.7 parts by mass

(7) Bis(2,4,6-trimethylbenzoyl)-phenylphosphine oxide (polymerization initiator): 0.2 parts by mass

A laminated-type non-aqueous electrolyte secondary battery was produced in the same manner as Example 1 except that the above solution for forming an insulating layer was used.

### Example 6

A sodium hydrogen carbonate with an average particle size of 10 μm was heat-treated in the same manner as Example 1. The heat-treated sodium hydrogen carbonate and the following materials were placed in a container at the following ratios, and then stirred for 12 hours to prepare a solution for forming an insulating layer.

(1) Sodium hydrogen carbonate (heat-treated at 70° C., average particle size: 10 μm): 25 parts by mass

(2) Boehmite (inorganic particles, average particle size: 0.6 μm): 4 parts by mass

(3) Urethane acrylate (polymerizable oligomer, “EBECRYL 8405” manufactured by DAICEL-CYTEC Company Ltd.): 4 parts by mass

(4) Tripropylene glycol diacrylate (polymerizable monomer): 1 part by mass

(5) Methyl ethyl ketone: 58.9 parts by mass

(6) Ethylene glycol: 5.7 parts by mass

(7) Bis(2,4,6-trimethylbenzoyl)-phenylphosphine oxide (polymerization initiator): 0.2 parts by mass

A laminated-type non-aqueous electrolyte secondary battery was produced in the same manner as Example 1 except that the above solution for forming an insulating layer was used.

### Comparative Example 1

While no sodium hydrogen carbonate was used, the following materials were placed in a container at the following ratios, and then stirred for 12 hours to prepare a solution for forming an insulating layer.

(1) Boehmite (inorganic particles, average particle size: 0.6 μm): 25.6 parts by mass

(2) Urethane acrylate (polymerizable oligomer, “EBECRYL 8405” manufactured by DAICEL-CYTEC Company Ltd.): 7.6 parts by mass

(3) Tripropylene glycol diacrylate (polymerizable monomer): 1.9 parts by mass

(4) Methyl ethyl ketone: 58.9 parts by mass

(5) Ethylene glycol: 5.7 parts by mass

(6) Bis(2,4,6-trimethylbenzoyl)-phenylphosphine oxide (polymerization initiator): 0.3 parts by mass

A laminated-type non-aqueous electrolyte secondary battery was produced in the same manner as Example 1 except that the above solution for forming an insulating layer was used.

### Comparative Example 2

A laminated-type non-aqueous electrolyte secondary battery was produced in the same manner as Example 1 except that the sodium hydrogen carbonate had an average particle size of 1 μm.

### Comparative Example 3

A laminated-type non-aqueous electrolyte secondary battery was produced in the same manner as Example 1 except that the sodium hydrogen carbonate had an average particle size of 25 μm.

### Comparative Example 4

A laminated-type non-aqueous electrolyte secondary battery was produced in the same manner as Example 1 except that the sodium hydrogen carbonate had an average particle size of 10 μm and the insulating layer had a thickness of 3 μm.

### Comparative Example 5

A laminated-type non-aqueous electrolyte secondary battery was produced in the same manner as Example 1 except that the sodium hydrogen carbonate had an average particle size of 10 μm and the insulating layer had a thickness of 45 μm.

### Comparative Example 6

A sodium hydrogen carbonate with an average particle size of 10 μm was heat-treated in the same manner as Example 1. The heat-treated sodium hydrogen carbonate and the following materials were placed in a container at the following ratios, and then stirred for 12 hours to prepare a solution for forming an insulating layer.

(1) Sodium hydrogen carbonate (heat-treated at 70° C., average particle size: 10 μm): 0.75 parts by mass

(2) Boehmite (inorganic particles, average particle size: 0.6 μm): 1 part by mass

(3) Urethane acrylate (polymerizable oligomer, “EBECRYL 8405” manufactured by DAICEL-CYTEC Company Ltd.): 7.6 parts by mass

(4) Tripropylene glycol diacrylate (polymerizable monomer): 1.9 parts by mass

(5) Methyl ethyl ketone: 58.9 parts by mass

(6) Ethylene glycol: 5.7 parts by mass

(7) Bis(2,4,6-trimethylbenzoyl)-phenylphosphine oxide (polymerization initiator): 0.3 parts by mass

A laminated-type non-aqueous electrolyte secondary battery was produced in the same manner as Example 1 except that the above solution for forming an insulating layer was used.

### Comparative Example 7

A sodium hydrogen carbonate with an average particle size of 10 μm was heat-treated in the same manner as Example 1. The heat-treated sodium hydrogen carbonate and the following materials were placed in a container at the following ratios, and then stirred for 12 hours to prepare a solution for forming an insulating layer.

(1) Sodium hydrogen carbonate (heat-treated at 70° C., average particle size: 10 μm): 28 parts by mass

(2) Boehmite (inorganic particles, average particle size: 0.6 μm): 1 part by mass

(3) Urethane acrylate (polymerizable oligomer, “EBECRYL 8405” manufactured by DAICEL-CYTEC Company Ltd.): 3 parts by mass

(4) Tripropylene glycol diacrylate (polymerizable monomer): 0.8 parts by mass

(5) Methyl ethyl ketone: 58.9 parts by mass

(6) Ethylene glycol: 5.7 parts by mass

(7) Bis(2,4,6-trimethylbenzoyl)-phenylphosphine oxide (polymerization initiator): 0.2 parts by mass

A laminated-type non-aqueous electrolyte secondary battery was produced in the same manner as Example 1 except that the above solution for forming an insulating layer was used.

The following elevated temperature test was performed on the non-aqueous electrolyte secondary batteries of Examples 1 to 6 and Comparative Examples 1 to 7, and the shutdown characteristics of each of the batteries were evaluated.

<Elevated Temperature Test>

Each of the batteries was placed in a thermostatic oven, and the temperature was raised from 30° C. to 160° C. at a rate of 1° C. per minute to measure changes in the internal resistance of the battery. In this case, the battery temperature was measured by attaching a thermocouple thermometer to the surface of the battery. The internal resistance of the battery was measured every second using a resistance meter “Hi TESTER” manufactured by HIOKI E. E. CORPORATION while the temperature was raised. In the battery temperature range of 100 to 150° C., shutdown was considered to occur when the maximum value of the internal resistance of the battery was increased to at least five times larger than the internal resistance at 30° C.

Table 1 shows the results. Table 1 also shows the average particle size of the sodium hydrogen carbonate, the thickness of the insulating layer, and the content of the sodium hydrogen carbonate with respect to the total volume of the insulating layer.

TABLE 1

| | | | Content | |
|---|---|---|---|---|
| | | | of sodium | |
| | Average | Thickness of | hydrogen | Presence or |
| | particle size | insulating layer | carbonate | absence of |
| | (μm) | (μm) | (vol %) | shutdown |
| Ex. 1 | 3 | 20 | 50 | occur |
| Ex. 2 | 17 | 20 | 50 | occur |
| Ex. 3 | 10 | 7 | 50 | occur |
| Ex. 4 | 10 | 35 | 50 | occur |
| Ex. 5 | 10 | 20 | 8 | occur |
| Ex. 6 | 10 | 20 | 77 | occur |
| Comp. | — | 20 | 0 | not occur |
| Ex. 1 | | | | |
| Comp. | 1 | 20 | 50 | not occur |
| Ex. 2 | | | | |
| Comp. | 25 | 20 | 50 | (short circuit) |
| Ex. 3 | | | | |
| Comp. | 10 | 3 | 50 | (short circuit) |
| Ex. 4 | | | | |
| Comp. | 10 | 45 | 50 | (large resistance) |
| Ex. 5 | | | | |
| Comp. | 10 | 20 | 2 | not occur |
| Ex. 6 | | | | |
| Comp. | 10 | 20 | 83 | (short circuit) |
| Ex. 7 | | | | |

It is evident from Table 1 that the non-aqueous electrolyte secondary batteries of Examples 1 to 6 of the present invention exhibited good shutdown characteristics. This may be because the sodium hydrogen carbonate added to the insulating layer decomposed when the battery temperature rose, and due to the pressure of the gas generated, the positive electrode and the negative electrode were separated from each other to increase the internal resistance.

On the other hand, shutdown did not occur in Comparative Examples 1, 2, and 6, since no sodium hydrogen carbonate was added to the insulating layer in Comparative Example 1, the average particle size of the sodium hydrogen carbonate was small in Comparative Example 2, and the content of the sodium hydrogen carbonate was low in Comparative Example 6.

Moreover, a short circuit occurred in Comparative Examples 3, 4, and 7, since the average particle size of the sodium hydrogen carbonate was large in Comparative Example 3, the thickness of the insulating layer was small in Comparative Example 4, and the content of the sodium hydrogen carbonate was high in Comparative Example 7. In Comparative Example 5, the initial internal resistance was 2Ω because of a large thickness of the insulating layer. This value was larger than the initial internal resistance in Example 1, which was 0.8Ω. Therefore, Comparative Example 5 was not qualified as a battery.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

### DESCRIPTION OF REFERENCE NUMERALS

Laminated-type non-aqueous electrolyte secondary battery
2 Outer package
3 Positive electrode external terminal
4 Negative electrode external terminal

1. A non-aqueous electrolyte secondary battery comprising:
a positive electrode;
a negative electrode; and
a non-aqueous electrolyte,
wherein an insulating layer is provided between the positive electrode and the negative electrode,
the insulating layer contains at least one type of hydrogen carbonate selected from a sodium hydrogen carbonate and a potassium hydrogen carbonate,
the hydrogen carbonate has an average particle size of 2 to 20 μm,
a content of the hydrogen carbonate is 5 to 80 vol % of a total volume of the insulating layer, and
the insulating layer has a thickness of 4 to 40 μm.

2. The non-aqueous electrolyte secondary battery according to claim 1, wherein the insulating layer further contains a resin having a cross-linked structure and inorganic particles, and
the insulating layer has micropores.

3. The non-aqueous electrolyte secondary battery according to claim 2, wherein the insulating layer is formed on the positive electrode or the negative electrode.

4. The non-aqueous electrolyte secondary battery according to claim 1, wherein the insulating layer further contains a microporous film, and
the hydrogen carbonate is located in an inside or a surface of the microporous film.

5. The non-aqueous electrolyte secondary battery according to any one of claims 1 to 4, wherein the hydrogen carbonate is heat-treated at a temperature lower than a decomposition temperature of the hydrogen carbonate.

6. The non-aqueous electrolyte secondary battery according to claim 1, further comprising a polyolefin microporous film between the positive electrode and the negative electrode.

7. The non-aqueous electrolyte secondary battery according to claim 6, wherein the microporous film is composed of polyethylene fine particles, and
the microporous film has a thickness of 1 to 10 μm.
